(19) United States
(12) Patent Application Publication
(10) Pub. No.: US 2013/0208239 A1
(43) Pub. Date: Aug. 15, 2013

(54) PROCESS FOR MANUFACTURING A POLARIZED OPTICAL ARTICLE AND POLARIZED OPTICAL ARTICLE

(71) Applicants: Peiqi Jiang, Tarpon Springs, FL (US); Bruce Keegan, Seminole, FL (US)

(72) Inventors: Peiqi Jiang, Tarpon Springs, FL (US); Bruce Keegan, Seminole, FL (US)

(21) Appl. No.: 13/396,724

(22) Filed: Feb. 15, 2012

(51) Int. Cl. G02C 7/12; B32B 37/02; B32B 38/10; B32B 37/12; B32B 37/10; B32B 37/14; G02B 5/30; B32B 37/06

(52) U.S. Cl. 351/159.56; 359/488.01; 156/305; 156/272.2; 156/272.6; 156/285; 156/280; 156/250

(57) ABSTRACT

A process for manufacturing a polarized optical device and the resulting optical device. In the process, an optical device is coated with an adhesive. A PVA polarizing film is moistened to render it formable. The PVA polarizing film is laminated on to the adhesive coating so that the PVA polarizing film forms to the shape of the optical device. The film, adhesive, device ensemble is then heat annealed. The PVA polarizing film is then contacted with a boric acid solution to crosslink the PVA so that it can withstand use and further processing. A polarized optical device includes an adhesive disposed between an optical base element and a PVA polarizing film.

### BACKGROUND OF THE INVENTION

1. Field of the Invention

The invention relates to a process for manufacturing a polarized optical article and a polarized optical article.

2. The Prior Art

In certain optical applications, including sunglasses, polarized optics are desirable since they reduce glare while providing a high level of transmission. Polarized optics typically incorporate a wafer containing a polarizing film The wafer includes a polarized film based on a PVA (polyvinyl alcohol) layer sandwiched between two identical or different material layers selected from, for example, TAC (cellulose triacetate), CAB (cellulose acetate butyrate), or PC (polycarbonate). The polarizing film is delicate and the sandwich layers help protect the film during manufacturing, where it is combined with the optical device, and other post-processing steps.

Pre-forming a polar PVA film is a known technology for film casting process to make a polar lens. The PVA film is pre-formed onto a glass mold to make a desired curve. A thermoset material is then cast against the film to form a polarized article. However, this preforming technology has not been applied to a previously manufactured lens, i.e. to make a laminated polarized lens from existing clear semi-finished (SF) or finished lens.

Polar wafer lamination with an adhesive has been disclosed and published to make a polar lens product. These approaches use a TAC-PVA-TAC wafer where the polyvinyl (PVA) film is sandwiched between protective cellulose triacetate layers. The wafer will need to be pre-formed and thermal stabilized before lamination. Then, an adhesive was applied onto the TAG PVA-TAC surface for subsequent lamination. The pre-forming and lamination requires a two step process. An example of such a two step process is disclosed in U.S. Pat. No. 7,128,415.

Another approach described in U.S. Pat. No. 7,776,239 includes PVA film forming and coating on both side of the PVA film. The coated PVA film is then glued onto a lens, or a lens is cast or injection molded on to the file to obtain a polarized lens for an ophthalmic application.

Certain other approaches have been proposed. The WIPO Publication WO 2009/054835 uses a polar film devoid of a TAC, CAB or PC outer protective layer. However, as a substitute to protect the delicate film, they coat the inner and outer surfaces with epoxy. A hard epoxy is applied to the outer surface to provide scratch resistance. A soft epoxy is applied on the inner surface to act as a buffering gel between the film and the base material. Film forming and multiple epoxy forming steps result in additional processing steps.

Accordingly, there is a need for a more efficient process for manufacturing a polarized optical article along with a thinner polarized optical article.

### SUMMARY OF THE INVENTION

Therefore, it is an object of an embodiment of the present invention to provide a process for manufacturing a polarized optical article.

It is another object to provide a process where PVA film forming and lamination are combined in to a single efficient step.

It is a further object to stabilize the laminated PVA film so it can be process further.

It is another object to present a process that is optimized for use with ophthalmic lenses.

According to a first embodiment of the invention, there is provided a process for manufacturing a polarized optical device. The first step of the process includes coating a surface of an optical device with an adhesive. A flat polyvinyl alcohol (PVA) polarizing film is subjected to moisture to render it formable. The PVA polarizing film is laminated on to the adhesive coating so that the moist fiat PVA film forms to the shape of the surface of the optical device. The laminated PVA polarizing film is contacted with a chemical solution to crosslink the PVA.

The adhesive coating has two opposed sides and after the laminating step, one side of the adhesive coating is in direct contact with the optical device and the opposite side is in direct contact with the PVA polarizing film. The coating step includes applying a liquid adhesive to the surface of the optical device and allowing the liquid coating to dry to form a solid adhesive coating layer having a thickness between about 2 and about 8 microns.

The coating step includes spin coating a hot melt adhesive (HMA) on to the surface of the optical device. The adhesive may be one of a hot melt adhesive (HMA); a bi-layer adhesive system; a first latex adhesive layer and a second HMA layer; a first gamma-aminopropyltriethoxysilane adhesive and a second HMA layer; a tri-layer adhesive system; and a first latex adhesive layer, a second layer and a third latex adhesive layer.

The optical device is made from a material selected from the group consisting of a thermoplastic material and a thermoset material. Prior to said coating step, the optical device is pre-treated by one of caustic washing, UV treatment, plasma treatment or corona treatment.

The laminating step includes (i) applying pressure or vacuum to press the PVA polarizing film on to the adhesive coating to form a PVA polarizing film, adhesive and optical device ensemble, (ii) heating the ensemble, and (iii) drying the ensemble. Following the laminating step, the process includes the further step of heat annealing the ensemble. Heat annealing includes subjecting the ensemble to a temperature in the range of about 80 degrees C. to about 120 degrees C. for between about 1 hour to about 6 hours.

The contacting step includes subjecting the ensemble to a boric acid solution having a. concentration between about 1 percent to about 5 percent by weight, and a temperature between about 20 degrees C. and about 80 degrees C., for between about 1 minute to about 60 minutes. The PVA polarizing film includes two opposed sides and wherein said contacting step comprises contacting the PVA with a boric acid solution on one side of the PVA polarizing film, while the other side is in direct contact with the adhesive coating.

The optical device is selected from an ophthalmic device, an ophthalmic lens, a finished lens, a semi-finished (SF) lens and an optical display. The optical device is selected from the group consisting various surface curve or base, such as a sphere or aspheric or a PAL curve surface that is to be laminated with PVA polar film. The optical device comprises a semi-finished (SF) lens and following the annealing step, the process further includes the step of surfacing the SF lens. The optical device comprises an ophthalmic lens and following the annealing step, the process further includes the step of applying a hard coat layer to at least the PVA polarizing film and/or edging the ophthalmic lens.

There is also provided an optical device or ophthalmic lens manufactured according to the process of claim 1.

According to another embodiment of the invention, there is provided a polarized optical device having at least three layers which are stacked in the following order. First, an optical base element having a surface made from a thermoplastic or thermoset material. Second, a polyvinyl alcohol (PVA) polarizing film having (a) an inner side conformed to the shape of said optical base element's surface and (b) a boric acid-treated-crosslinked outer side that forms an uncoated, exposed exterior surface. Third, an adhesive layer (i) disposed on said optical base element's surface and (ii) directly in contact with said inner side of said PVA polarizing film.

### BRIEF DESCRIPTION OF THE DRAWINGS

The advantages, nature, and various additional features of the invention will appear more fully upon consideration of the illustrative embodiments now to be described in detail in connection with accompanying drawings. In the drawings wherein like reference numerals denote similar components throughout the views:

FIG. 1A is a schematic view of various components used according o an embodiment of the inventive method,

FIG. 1B is a further schematic view of the laminated components.

FIG. 2 is a flowchart outlining various steps according to an embodiment of the inventive method.

FIG. 3 is a schematic view of an optical article apparatus.

### DETAILED DESCRIPTION OF THE PREFERRED EMBODIMENTS

Polarized filters are useful in many applications including sunglasses. Polar films are delicate and brittle. They are also very sensitive to environmental conditions like moisture and temperature which can adversely effect the film's mechanical properties.

Today, there are two main methods or processes to make a polarized lens product: one is polar wafer casting or injection with a pre-formed polar wafer (PVA wafer or PC-PVA-PC wafer); another is polar wafer lamination with pre-formed polar TAC-PVA-TAC wafer. In both case, the wafer needs to be formed in advance to get a proper curve and then used for either casting/injection or film lamination to get a final polarized lens. Generally, this is considered as a two-step polar process, which can cost lots of labor and steps in manufacturing.

This innovation discloses a new method and process of making a polarized lens or optical parts by PVA film lamination which has many advantages compared to current polar film lamination or polar film cast or injection process.

Therefore, it will be of great advantage have a method which combines the forming and lamination in one step to make a polar lens product. This combined lamination step is then used in combination with a chemical treatment, such as boric acid treatment step to stabilize the PVA film for optical applications, especially for ophthalmic lenses.

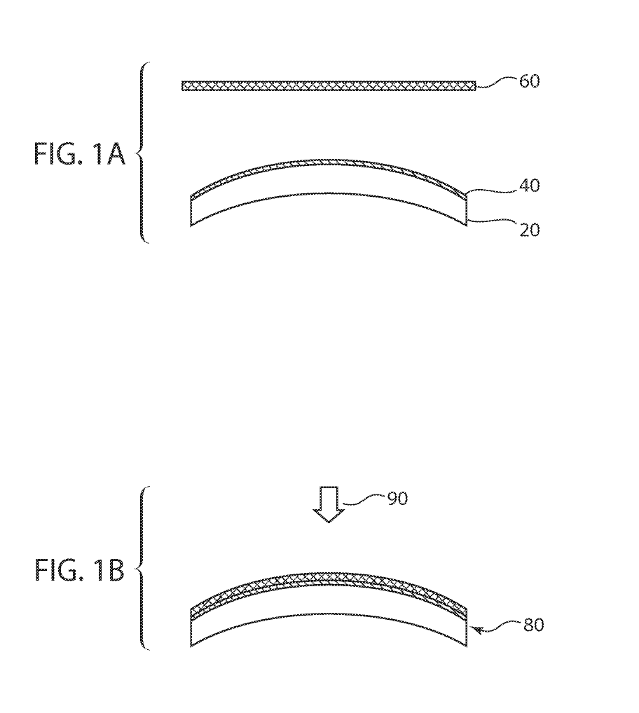

Another advantage of the method and apparatus of the invention is that the resulting polar lens will be much thinner than cast or injection lenses using a TAC or PC polar lamination process. By eliminating the TAC or PC protective layers, there will only be a 20 μm PVA film attached to the lens surface with a thin adhesive layer. A diagram of the various components used in the process is shown in FIG. 1A. A plastic lens 20 is shown at the lower portion of the diagram. it should be noted that an optical device made from a thermoplastic material or thermoset material may serve as the optical base material in place of lens 20. In other words, a plastic optical device that requires an intimate bond with a polar filter can be manufactured according to the method of the invention.

An adhesive 40 is coated onto a surface of lens 20. The adhesive portion of the sandwich may include one or multiple layers of adhesive materials. In the case of one adhesive layer, a liquid adhesive is coated on to a surface of lens 20. For example, a hot melt adhesive (HMA) is spin coated on to a convex surface of lens 20.

A bi-layer adhesive system may be employed according to U.S. patent application Ser. No. 13/126,367 entitled Bi-Layer Adhesive for Lens Lamination, the contents of which is incorporated herein by reference thereto.

A tri-layer adhesive system may be employed according to WIPO Publication WO 2011/053329, the contents of which is incorporated herein by reference thereto. In a tri-layer system the latex is to be coated so that it contacts the PVA film,

A polyvinyl alcohol (PVA) polar film 60 is laminated on to the adhesive coating 40. In this application, references to PVA film mean a single layer devoid of outer protective coatings. A PVA polar film that is coated with one or more TAC, CAB or PC protective layers is referred to as a PVA polar wafer.

The laminated ensemble 80 is shown in FIG. 1B and includes a plastic base, an adhesive layer and a PVA film with an exposed surface.

However, since the PVA film is very thin and brittle and its mechanical properties are very sensitive to the moisture or temperature, even after the film is laminated onto a lens surface, the obtained lens cannot be hardcoated and heated in high temperature due to PVA film deformation or absorption to water. Therefore, the PVA film needs to be stabilized after one step laminated to a lens surface so that the laminated PVA polar lens can be coated and heated for eye wear applications.

Arrow 90 represents a stabilization step, for example, a process to crosslink the PVA. In a practical embodiment, the stabilization step was carried out by contacting the PVA with a chemical solution, such as a solution containing boric acid.

In this innovation, a new process is proposed to form a PVA film directly onto a lens whose front surface has been coated by a hot melt adhesive in advance. This process is done in one step of forming+lamination.

Then, the laminated SF polar lens is chemically treated by Boric acid to further stabilize the PVA film before the next steps of HC or Rx surfacing. Without Boric acid treatment, the PVA film on the laminated lens is not stable and can be damaged by moisture or environment or coating.

After boric acid treatment on PVA film that has been laminated onto a lens, the surface of the laminated lens is more stable and can be further processed to get a final hard coated Rx lens.

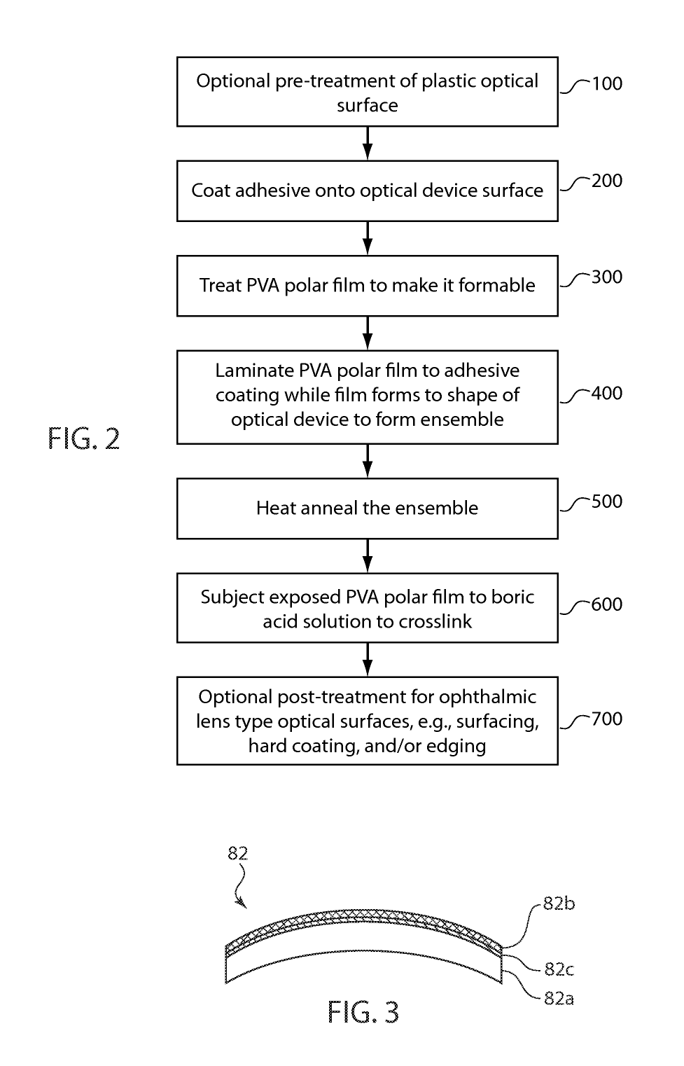

A detailed technical description of the method will now be provided with reference to the flowchart of FIG. 2. Step 100 refers to pre-treatment of the plastic optical device. The pre-treatment is to clean the surface and to improve adhesion. Of course, the pre-treatment options depend on the condition of the optical device and the materials. Two types of pre-treatment include caustic washing and UV exposure, with caustic washing being the preferred type of pre-treatment.

In step 200 a surface of the optical device is coated with an adhesive. if an ophthalmic lens is being polarized, it may be desirable to laminate the polar film on to the outer surface of the lens, i.e. the surface which will be facing away from the wearer. In such a case, the adhesive will be applied to the convex surface. In other application, it may be desirable to apply the adhesive and film to the inner or concave surface. The advantages of the method and apparatus according to the invention do not depend on the selection of the laminating surface.

As mentioned above a single, double or triple layer of adhesive may be used. In practical tests a hot melt adhesive (HMA) has worked well, for example, an HMA sold under the designation UD 108 available from Bond Polymer international. The HMA can be coated on to the optical device by any suitable means. In a preferred embodiment, the HMA is spin coated, for example, spin coated to a thickness of 2-8 microns on to a convex surface of an ophthalmic lens, The HMA is a water based dispersion and spin coated, and then dried to form a solid layer with a uniform thickness.

In the next step 300, the PVA polar film is subjected to moisture to render it formable. The PVA film comes in a standard thickness of 20 microns from the manufacturer. In the examples given below, a 2400 grade PVA film from Onbitt Corporation is utilized. The other 1300 grade material would be suitable for use in the method and apparatus according to the invention. PVA films of 10 micron thickness or less should be avoided. PVA films up to about 100 microns in thickness would be suitable.

In step 400, the moist PVA film is then formed onto the adhesive coated plastic lens to obtain a laminated polar lens in one step of forming+lamination. Previously, PVA moistening has been used to pre-form the PVA film during a process to incorporate the film in to a wafer. The wafer is then laminated to an optical device or lens surface. An important aspect of the invention is the efficient combination of the forming and laminating processes in to a single step. Lamination, which also includes forming, can be carried out by any suitable method. For an ophthalmic lens, lamination can include balloon pressure of vacuum pressure in conjunction with heating and drying. Heating will facilitate thermo-forming of the PVA film to the shape of the lens surface. Drying will remove the moisture introduced in step 300, so that the film will hold its newly formed shape. The structure including the dry PVA film laminated to the optical device by a solid adhesive layer is referred to as the ensemble.

In step 500, the ensemble is then further heated in a heat annealing step. Heat annealing takes place within a temperature range of about 80 degrees C. to about 120 degrees C., for between about 1 hour and about 6 hours. in practical tests, heat annealing occurred at 100 degrees C. for 3 hr, to get good bonding between the PVA film and the plastic article or lens.

In step 600, the laminated ensemble is chemically treated by boric acid to crosslink the PVA film surface so that it can be coated or further processed. In the case of an ophthalmic lens a coating, hard coat or Rx processed may be employed to make a clear polar lens for eyewear. The boric acid should be presented in a solution having a boric acid concentration between about 1% to about 5% by weight. In this step, the ensemble should be exposed to the boric acid solution, for example via a dip bath, for between about 1 minute to about 60 minutes. The solution should be maintained within a temperature range from about 20 degrees C. to about 60 degrees C. Exposure outside the given ranges may not adequately stabilize the PVA material which can be damaged or otherwise adversely effected by subsequent handling to processing steps.

Step 700 refers to various optional post-treatment operations. Of course, the type of post-treatment will depend on the nature of the optical article and its intended application. In the case of a semi-finished ophthalmic lenses, the ensemble may be subject to a surfacing operation, where a custom prescription (Rx) is ground in to a surface of the lens. The grinding will take place on the surface that does not have the PVA film laminated thereto. For example, if the PVA film is laminated to the exterior convex surface, then grinding will be performed on the interior concave surface, i.e. the surface facing the wearer's eye. Ensembles consisting of ophthalmic lenses may also be edged to fit within a frame or be used for rimless spectacles. Ensembles consisting of ophthalmic lenses may also be coated with a variety of optical coatings, for example, protective coatings, hard coatings, AR coatings, photochromic coatings, tinted coating, anti-fog coating, anti-smudge coating. The above steps will be further described in connection with examples and comparative examples.

### Example 1

A polycarbonate (PC) semi-finished (SF) lens having a curvature (1.25 base) was caustic washed and coated with an hot melt adhesive (HMA) solution. The adhesive solution was UD 108 from Bond polymer International diluted 10% in water. The HMA was applied via spin coating to obtain a uniformly thick layer and dried to a final thickness of about 6 microns.

Then, a PVA polar film 2400 grade made by Onbitt Corp having a thickness of 20 microns was laminated to the adhesively coated surface of the lens. Lamination occurred via a front side lamination (ESL) process under pressure of 15 psi at 150 C for 2 min, this process being described to US 2009/0165932.

After a quick lamination, the lens was heated again in oven at 100 degrees C. for 3 hours resulting in very good bonding between the PVA film and the PC lens. Finally, the laminated PVA polar lens was chemically treated by a boric acid solution containing 4.75% boric acid by weight in water. A SF lens holding bracket secured the lens during dipping in a bath for 30 minutes at room temperature containing the boric acid solution. The obtained SF lens was then surfaced to −6.00 and coated with abrasion-resistant (HC) coating, using known sol-gel processes, as described in EP 0 614 957 can be employed, and post cured at 100 degrees C. for 3 hours. The final lens has good polarization properties and clear coating on surface. It also has very good adhesion between the PVA film and the PC lens surface. There is no film delamination after edging with Triumph.

Polarization was checked with polarized filter to ensure good polarization performance. The light passing through the lens was completely eliminated when it was rotated with respect to the polar filter. Adhesion was checked by crosshatch with tape. Good adhesion was noted, with no film removed after test. The clear coating was inspected with Essilor R17 tight inspection and mini spot light, with little or no haze detected by the naked eye. The Edging test was conducted with 5 lenses by Triumph and with no film delamination or separation from the lens after edging.

### Comparative Example 1

Example 1 was repeated except the boric acid treatment on the PVA surface after lamination was omitted. The Obtained lens after hardcoating (HC) showed a high haze, that is haze easily detectable by the naked eye. The PVA film surface was damaged during HC treatment. This is because the PVA film is not stable when exposed to water based HC coating without chemical treatment of the boric acid. Therefore, the laminated lens cannot be used in commercial applications.

### Example 2

Example 1 was repeated except the boric acid treated PVA SF polar laminated lens was directly coated with abrasion-resistant (HC) coating solution. The obtained coated PVA polar SF was very clear and stable for further Rx applications. Adhesion was tested with crosshatch tape and the score is 0.

Comparative Example 2

Example 2 was repeated except there was no boric acid treatment on PVA SF polar laminated lens. After HC, the obtained lens was very hazy. The surface of the PVA film showed some damage during HC because the PVA film is not stable when exposed to the water based HC solution.

### Example 3

A Lineis® (épisulfides polymer sold by Essilor) SF lens (0.75 base) was caustic washed and coated by UD 108 adhesive and dried to about a 6 micron uniform thickness via spin coating. A 20 micron thick PVA was laminated onto the lens and post annealed with the same process as in Example 1. Then the PVA laminated lens was chemically treated in a heated boric acid solution for 1 min at 75 degrees C. The obtained SF was then rinsed and dried at 100 degrees C. for 3 hours. Finally, the obtained lens was surfaced to −12.0 and then hardcoated as Example 1. The obtained lens was very clear and stable in curve. The lens exhibited the same good level of polarization.

### Comparative example 3

Example 3 was repeated except that the boric acid treatment on PVA film after lamination was omitted. The lens was deformed a lot on the surface due to high temperature post cure of the laminated Lineis® lens and the PVA film did not remain stable through to the HC during high temperature curing.

As described, the process can be used to laminate PVA polar films to a wide variety of optical devices, for example, LCD monitors, 3D film applications, lenses, etc. This innovation can be used in ophthalmic lens applications to make any polar lens products. FIG. 3 shows a polarized optical device 82 according to an apparatus aspect of the invention. Polar optical device 82 has also been referred to as the “ensemble”. Polar optical device 82 includes three layers, without intermediate layers, in the following order. For the sake of convenience, top and bottom will be used to refer to the stack configuration. An optical base element 82a is on the bottom, with a PVA film 82b on top, with an adhesive layer 82c in the middle.

Optical base element 82a includes an upper surface, facing adhesive layer 82e. Optical base element is made from plastic, for example, a thermoplastic or thermoset material. While optical base element may comprise any type of optical device benefitting from a polarized filter, an ophthalmic lens has been selected for illustration. This optical base element when it represent an optical lens may be selected from, for instance: polyamides; polyimides; polysulfones polycarbonates and copolymers of polycarbonate and polyethylene terephtalate) polyolefins such as polynorbornene ; homo- and copolymers of allyl carbonates of linear or branched aliphatic or aromatic polyols, such as homopolymers of diethylene glycol bis(allyl carbonate) (CR 39®) homo- and copolymers of (meth)acrylic acid and esters thereof, which may be derived from bisphenol A ; homo- and copolymers of thiometh)acrylic acid and esters thereof homo- and copolymers of poly(thio)urethane ; epoxy homo- and copolymers ; and episulfide homo- and copolymers.

The optical base element can be an uncorrective or corrective or ophthalmic lens, which could be selected for example from a semi-finished lens, or a finished lens.

PVA film 82b has an inner side, shown as the lower side in the figure. The inner (lower) side is conformed to the shape of the upper surface of optical base element 82a. The outer (upper) side comprises a stabilized PVA material. The upper side is uncoated and exposed, meaning there is no TAC or PC protective coating that typically accompanies PVA films, it should be understood that ensemble 82 may represent an intermediate product. Such intermediate product may be subject to further processing or coating operations. The exposed surface comprises a crosslinked PVA material, and more particularly comprises a chemical treated cross-linked PVA material such as a boric acid treated cross-linked PVA material. The PVA film is about 20-100 microns thick.

Adhesive layer 82 comprises a single or multiple layer adhesive system. For example, two or three adhesive layers individually spin coated and dried. In the ensemble 82, adhesive layer 82c is a solid layer of about 2-8 microns thick. The single adhesive, or the bottom layer of adhesive, is disposed directly on the optical base element's upper surface. The single adhesive, or the top layer of adhesive, is directly in contact with the inner (lower) side of the PVA film. In the case of one adhesive layer, the entire laminate thickness (adhesive plus film) is only 22-28 microns thick. While prior art polarized PVA films require a TAC or PC protective layer, the PVA film of the ensemble is protected by a boric acid treated, crosslinked, stabilized micro layer of polyvinyl alcohol on the upper exposed surface of the film.

While boric acid has been used previously as a crosslinking agent, it has not been disclosed for use in combination with a lamination process, especially in optical or ophthalmic applications. The examples and comparative examples, show the usefulness of the boric acid treatment when laminated lenses are to be heat annealed and hard coated in a water based solution. Heat annealed and hard coated lenses cannot be manufactured without the boric acid treatment.

In summary, the process described herein provides an improvement by simplifying the manufacture of polarized optical devices. The process is flexible in that various adhesive systems can be employed. The process is more efficient by using the lamination process to simultaneously perform a forming process to conform the film to the shape of the optical device surface. The chemical treatment with boric acid stabilizes the PVA film, Such stabilization allows the laminated ensemble to be readily handled, and lenses to be surfaced, hardcoated and edged. Other aspects of the invention include optical devices and lenses manufactured according to the process and various options thereof A further aspect of the invention includes a polarized optical device apparatus having an adhesive coating directly contacting a boric-acid stabilized, cross-linked PVA film.

Having described preferred embodiments for manufacturing polarized optical devices and lenses along with the resulting apparatus (which are intended to be illustrative and not limiting), it is noted that modifications and variations can be made by persons skilled in the art in light of the above teachings. For example, other pre- or post-treatment steps can be employed depending on the intended application. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. A process for manufacturing a polarized optical device comprising the steps of:
coating a surface of an optical device with an adhesive;
subjecting a flat polyvinyl alcohol (PVA) polarizing film to moisture to render it formable;
laminating the PVA polarizing film on to the adhesive coating so that the moist flat PVA film forms to the shape of the surface of the optical device; and
contacting the laminated PVA polarizing film with a chemical solution to crosslink the PVA.

2. The process of claim 1, wherein the adhesive coating has two opposed sides and after the laminating step, one side of the adhesive coating is in direct contact with the optical device and the opposite side is in direct contact with the PVA polarizing film.

3. The process of claim 2, wherein coating step includes applying a liquid adhesive to the surface of the optical device and allowing the liquid coating to dry to form a solid adhesive coating layer having a thickness between about 2 and about 8 microns.

4. The process of claim 3, wherein the coating step includes spin coating a hot melt adhesive (HMA) on to the surface of the optical device.

5. The process of claim 2, wherein the adhesive is selected from the group consisting of:
a hot melt adhesive (HMA),
a bi-layer adhesive system,
a first latex adhesive layer and a second HMA layer,
a first gamma-aminopropyltriethoxysilane adhesive and a second HMA layer,
a tri-layer adhesive system, and
a first latex adhesive layer, a second HMA layer and a third latex adhesive layer.

6. The process of claim 1, wherein the optical device is made from a material selected from the group consisting of a thermoplastic material and a thermoset material.

7. The process of claim 1, wherein prior to said coating step, the optical device is pre-treated by one of caustic washing, UV treatment, plasma treatment or corona treatment.

8. The process of claim 1, wherein the laminating step includes (i) applying pressure or vacuum to press the PVA polarizing film on to the adhesive coating to form a PVA polarizing film, adhesive and optical device ensemble, (ii) heating the ensemble, and (iii) drying the ensemble.

9. The process of claim 8, wherein following said laminating step, the process includes the further step of heat annealing the ensemble.

10. The process of claim 9, wherein the heat annealing step includes subjecting the ensemble to a temperature in the range of about 80 degrees C. to about 120 degrees C. for between about 1 hour to about 6 hours.

11. The process of claim 8, wherein said contacting step includes subjecting the ensemble to a boric acid solution having a concentration between about 1 percent to about 5 percent by weight, and a temperature between about 20 degrees C. and about 80 degrees C., for between about 1 minute to about 60 minutes.

12. The process of claim 1, wherein said PVA polarizing film includes two opposed sides and wherein said contacting step comprises contacting the PVA with a boric acid solution on one side of the PVA polarizing film, while the other side is in direct contact with the adhesive coating.

13. The process of claim 9, wherein the optical device is selected from the group consisting of an ophthalmic device, an ophthalmic lens, a finished lens, a semi-finished (SF) lens and an optical display.

14. The process of claim 9, wherein the optical device is selected from the group consisting various surface curve or base, such as a sphere or aspheric or a PAL curve surface that is to be laminated with PVA polar film.

15. The process of claim 9, wherein the optical device comprises a semi-finished (SF) lens and following the annealing step, the process further includes the step of surfacing the SF lens.

16. The process of claim 9, wherein the optical device comprises an ophthalmic lens and following the annealing step, the process further includes the step of applying a hard coat layer to at least the PVA polarizing film.

17. The process of claim 9, wherein the optical device comprises an ophthalmic lens and following the annealing step, the process further includes the step of edging the ophthalmic lens.

18. An optical device manufactured according to the process of claim 1.

19. An ophthalmic lens manufactured according to the process of claim 1.

20. A polarized optical device having at least three layers which are stacked in the following order comprising:
an optical base element having a surface and being selected from a material selected from the group consisting of a thermoplastic material and a thermoset material;
a polyvinyl alcohol (PVA) polarizing film having (a) an inner side conformed to the shape of said optical base element's surface and (b) a boric acid-treated-crosslinked outer side that forms an uncoated, exposed exterior surface; and
an adhesive layer (i) disposed on said optical base element's surface and (ii) directly in contact with said inner side of said PVA polarizing film.
